(19) United States
(12) Patent Application Publication
(10) Pub. No.: US 2019/0243993 A1
(43) Pub. Date: Aug. 8, 2019

(54) BARCODE READING DEVICE, BARCODE READING METHOD AND COMPUTER-READABLE STORAGE MEDIUM

(71) Applicant: CASIO COMPUTER CO., LTD., Tokyo (JP)

(72) Inventor: Tomonori IRIE, Tokyo (JP)

(21) Appl. No.: 16/266,795

(22) Filed: Feb. 4, 2019

(30) Foreign Application Priority Data
Feb. 5, 2018 (JP) 2018-017868

(51) Int. Cl. G06K 7/10; G06K 7/14

(52) U.S. Cl. CPC G06K 7/1092; G06K 7/1465; G06K 7/10722; G06K 7/10881

(57) ABSTRACT

A barcode reading device including a camera which is used to capture a barcode, an optical aiming device which emits an aim in an imaging direction of the camera, and a processor which executes processing including imaging control processing of controlling the camera to successively perform first image capturing that is performed with the aim being emitted by the optical aiming device and second image capturing that is performed without the aim being emitted, and reading processing of reading the barcode from a second captured image acquired by the second image capturing with reference to positional information of the aim in a first captured image acquired by the first image capturing.

### CROSS-REFERENCE TO RELATED APPLICATION

This application is based upon and claims the benefit of priority from the prior Japanese Patent Application No. 2018-017868, filed Feb. 5, 2018, the entire contents of which are incorporated herein by reference.

### BACKGROUND OF THE INVENTION

### 1. Field of the Invention

The present invention relates to a barcode reading device, a barcode reading method and a computer-readable storage medium for reading a barcode.

### 2. Description of the Related Art

Conventionally, hand-held scanners have been used as code reading devices for reading one-dimensional to two-dimensional barcodes. For example, Japanese Patent Application Laid-Open (Kokai) Publication No. 2001-184452 discloses such a scanner, which is capable of emitting an aimer formed by laser light or the like (i.e. an aim constituted by a light spot, a pattern or the like) in order to indicate a reading position of a barcode. With this scanner, the position and orientation thereof can be checked or adjusted with the aimer as a guide. Also, Japanese Patent Application Laid-Open (Kokai) Publication No. 2013-103163 discloses a technology for reading information from a barcode by identifying the barcode by detecting a black bar portion (symbol character) and a white bar portion (gap between characters) from an image captured by an image sensor.

### SUMMARY OF THE INVENTION

In accordance with one aspect of the present invention, there is provided a barcode reading device comprising: a camera which is used to capture a barcode; an optical aiming device which emits an aim in an imaging direction of the camera; and a processor which executes processing including: imaging control processing of controlling the camera to successively perform first image capturing that is performed with the aim being emitted by the optical aiming device and second image capturing that is performed without the aim being emitted; and reading processing of reading the barcode from a second captured image acquired by the second image capturing with reference to positional information of the aim in a first captured image acquired by the first image capturing.

In accordance with another aspect of the present invention, there is provided a barcode reading method for a barcode reading device including a camera which is used to capture a barcode, an optical aiming device which emits an aim in an imaging direction of the camera, and a processor, comprising: an imaging control step of controlling the camera to successively perform first image capturing that is performed with the aim being emitted by the optical aiming device and second image capturing that is performed without the aim being emitted; and a reading step of reading the barcode from a second captured image acquired by the second image capturing with reference to positional information of the aim in a first captured image acquired by the first image capturing.

In accordance with another aspect of the present invention, there is provided a non-transitory computer-readable storage medium having stored thereon a program that is executable by a computer in a barcode reading device including a camera which is used to capture a barcode, an optical aiming device which emits an aim in an imaging direction of the camera, and a processor, the program being executable by the computer to actualize processing comprising: imaging control processing of controlling the camera to successively perform first image capturing that is performed with the aim being emitted by the optical aiming device and second image capturing that is performed without the aim being emitted; and reading processing of reading the barcode from a second captured image acquired by the second image capturing with reference to positional information of the aim in a first captured image acquired by the first image capturing.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1A and FIG. 1B are diagrams showing the outer appearance of a scanner according to the present invention, of which FIG. 1A is a front view and FIG. 1B is a rear view;

FIG. 2 is a diagram showing the arrangement of a camera and the like in the scanner;

FIG. 3A is a diagram showing a pattern of an aimer;

FIG. 3B is a diagram showing a relationship between the aimer and an imaging area;

FIG. 4 is a block diagram showing the electrical structure of the scanner;

FIG. 5 is a flowchart showing barcode reading processing;

FIG. 6 is a timing chart showing a barcode reading operation;

FIG. 7A is a diagram showing an example of an emitted state of the aimer; and

FIG. 7B and FIG. 7C are diagrams showing a barcode-reading target area set in an image.

### DETAILED DESCRIPTION OF THE PREFERRED EMBODIMENTS

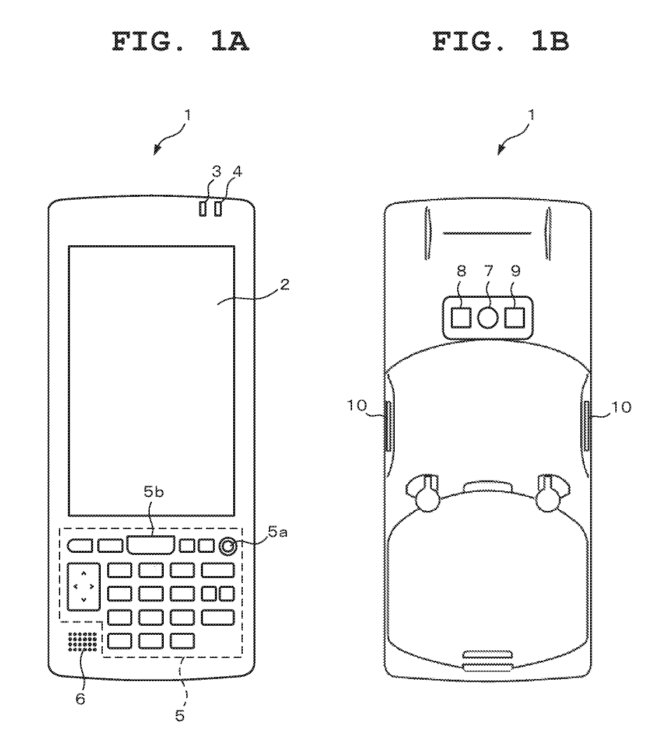

An embodiment of the present invention will hereinafter be described. FIG. 1A and FIG. 1B are diagrams showing the outer appearance of a handheld scanner 1 according to the present invention, of which FIG. 1A is a front view of the scanner 1 and FIG. 1B is a rear view of the scanner 1. The scanner 1 of the present embodiment is a handheld scanner for reading a barcode and has a function of emitting an aimer indicating a reading position of a barcode.

In FIG. 1A that is a front view of the scanner 1, a display 2, a first indicator 3, a second indicator 4, an operation key group 5, and a speaker 6 have been provided on the front side of the scanner 1.

The display 2 displays various types of information on a screen, and is used for the operation of the scanner 1 or data inputting by use of an attached stylus. The first indicator 3 and the second indicator 4 are LEDs (Light-Emitting Diodes) that are capable of emitting multiple colors of light as needed. The first indicator 3 is lit in a color corresponding to the power supply status of the scanner 1, and the second indictor 4 is lit or blinks in a color (green or red) corresponding to various statuses of the scanner 1 other than the power supply status.

The operation key group 5 is constituted by a plurality of keys including a power key 5a and a center trigger key 5b. The center trigger key 5b is used mainly for giving an instruction to read a barcode. Note that the other keys (whose reference numerals are omitted in the drawing) include function keys and numeric keys, and are used for various types of operations on the scanner 1. Also, on the sides of the scanner 1, side trigger keys 10 having a function similar to that of the center trigger key 5b are provided, as shown in FIG. 1B.

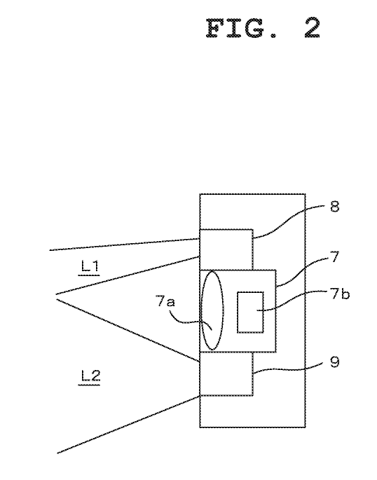

FIG. 1B is a rear view of the scanner 1. On the back surface of the scanner 1, a camera 7 for capturing a barcode or the like, an aimer emitting device 8, and an illuminator 9 are provided side by side. These components are combined to form a module and mounted to the scanner 1. FIG. 2 is a diagram showing the arrangement of the camera 7 and the like when the scanner 1 is viewed from the tip side, that is, the side on which the first and second indicators 3 and 4 are provided.

The camera 7 captures an image of a subject such as a barcode by an image sensor 7b through an imaging lens 7a. The aimer emitting device 8 emits laser light L1 forming an aimer that indicates a reading position of a barcode. The illuminator 9 emits auxiliary light L2 when a barcode or the like is captured. The direction of the emission of the aimer (laser light L1) and the auxiliary light 2 coincides with the imaging direction of the camera 7.

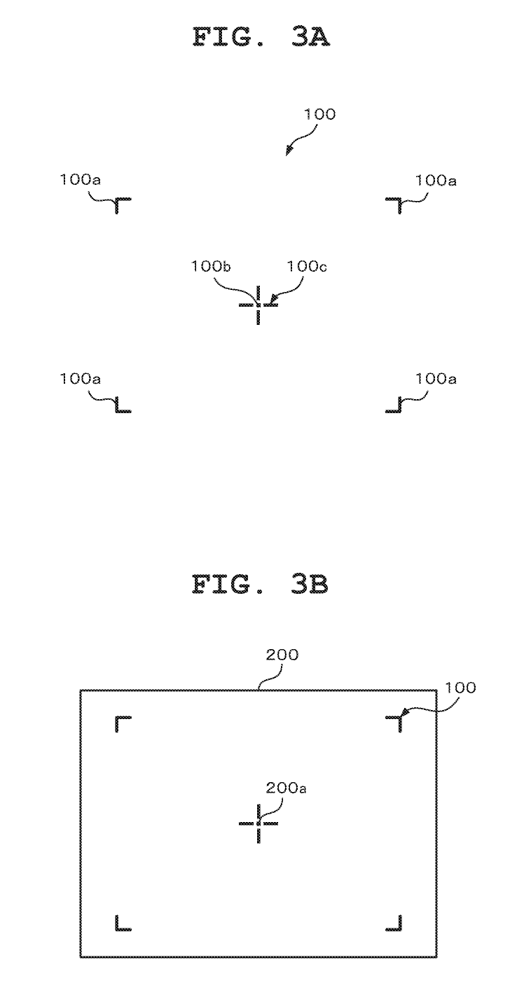

FIG. 3A is a diagram specifically showing a pattern of an aimer 100 that is emitted by the aimer emitting device 8. In the present embodiment, the aimer 100 includes four corners 100a, a center point 100b and a cruciform portion 100c. The four corners 100a represent the four corners of a quadrangle, and the center point 100b and the cruciform portion 100c represent the center of the quadrangle. The aimer emitting device 8 is mounted to the main body such that its optical axis (specifically, the optical axis of light displayed as the center point 100b) is inclined toward the optical axis (imaging optical axis) of the imaging lens 7a of the camera 7. The inclination direction and the inclination angle of the optical axis of the aimer emitting device 8 are set such that, when a distance between the scanner 1 and a barcode to be read is equal to a reference distance (such as 10 cm) designed therefor, the center point 100b of the aimer 100 coincides with the center 200a of the imaging area 200 of the camera 7, as shown in FIG. 3B.

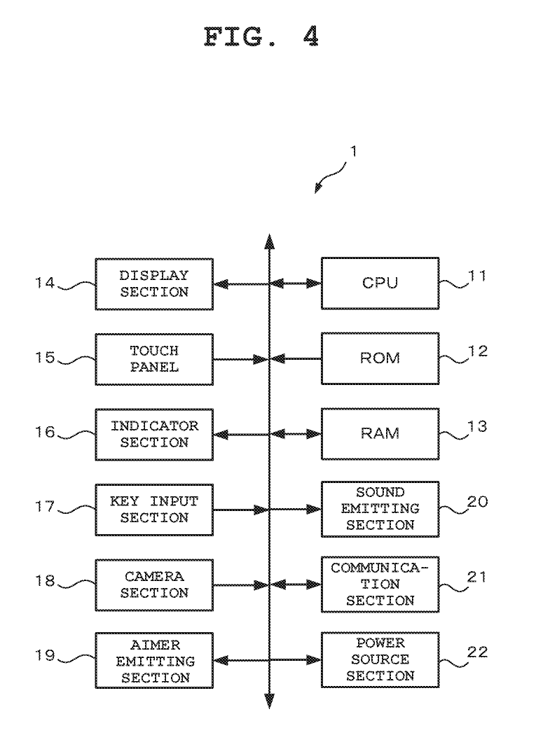

FIG. 4 is a block diagram showing the electrical structure of the scanner 1. This scanner 1 includes a CPU (Central Processing Unit) 11, a ROM (Read-Only Memory) 12 connected to the CPU 11, a RAM (Random Access Memory) 13, a display section 14, a touch panel 15, an indicator section 16, a key input section 17, a camera section 18, an aimer emitting section 19, a sound emitting section 20, a communication section 21 and a power source section 22.

The ROM 12 has stored therein a control program for causing the CPU 11 to control each section of the scanner 1 and execute barcode reading processing described later. The RAM 13 is a working memory that temporary stores various types of data when the CPU 11 executes barcode reading processing or other processing.

The display section 14 includes the display 2 and a drive circuit that drives the display 2. The display 2 is, for example, an LCD (Liquid Crystal Display) or an ELD (Electroluminescent Display). The touch panel 15 is a pressure-sensitive or capacitive touch panel integrally provided on a surface of the display 2 and provides information regarding a user operation to the CPU 11.

The indicator section 16 includes two LEDs (Light-Emitting Diodes) that function as the first indicator 3 and the second indicator 4, a high-luminance LED (Light-Emitting Diode) that serves as a light source of the illuminator 9 and a drive circuit that drives those LEDs. The key input section 17 is constituted by a plurality of keys, that is, each key of the operation key group 5 and the side trigger keys 10 and provides information regarding an operation performed by a user of the scanner 1 to the CPU 11.

The camera section 18 includes the image sensor 7b such as a CMOS (Complementary Metal Oxide Semiconductor) sensor constituting the camera 7, a drive circuit that drives the image sensor 7b and an image processing circuit that performs, on an imaging signal outputted from the image sensor 7b, analog processing and conversion processing for conversion into a digital signal, and performs various types of image processing such as brightness adjustment and white balance adjustment. This camera section 18 acquires a captured image showing a barcode and provides the image data thereof to the CPU 11. Note that image data provided to the CPU 11 is stored in the RAM 13.

The aimer emitting section 19 includes a laser diode that serves as a light source of the aimer emitting device 8, a laser drive power source circuit that supplies electric power to the laser diode, and the like. The sound emitting section 20 includes a sound generation circuit, an amplifier, and the speaker 6, and emits various types of alarm sounds as needed. The communication section 21 communicates with an external device (not shown) by wired or wireless communication as needed, and transmits, to the external device, code information (character string information) acquired from an arbitrary barcode. The power supply section 22 supplies electric power necessary for the operation of each section described above.

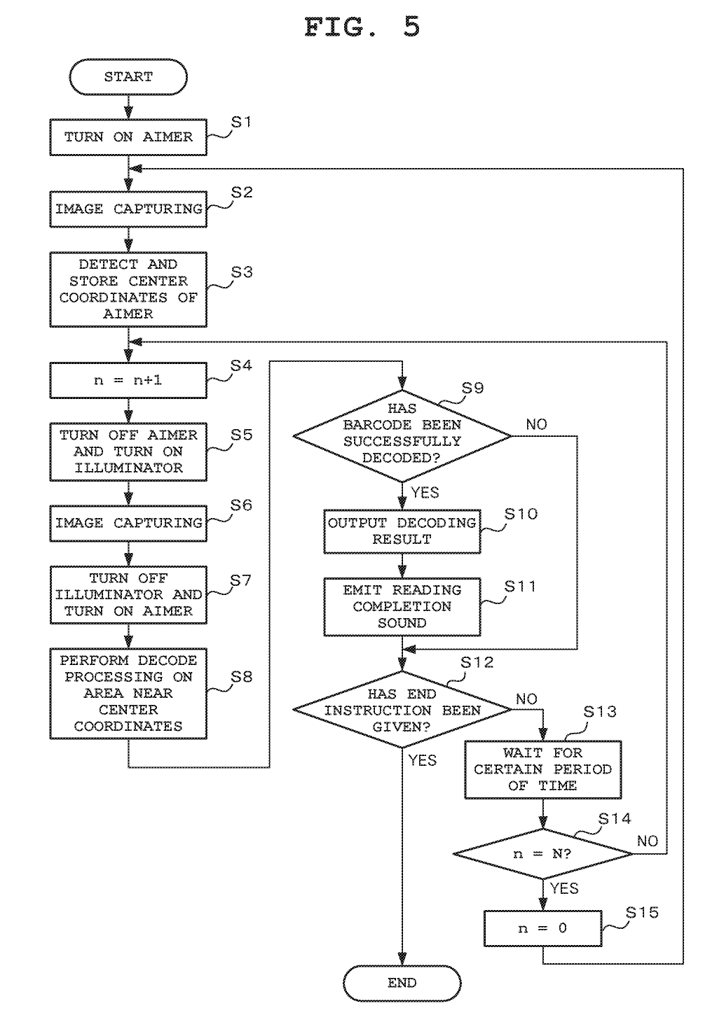

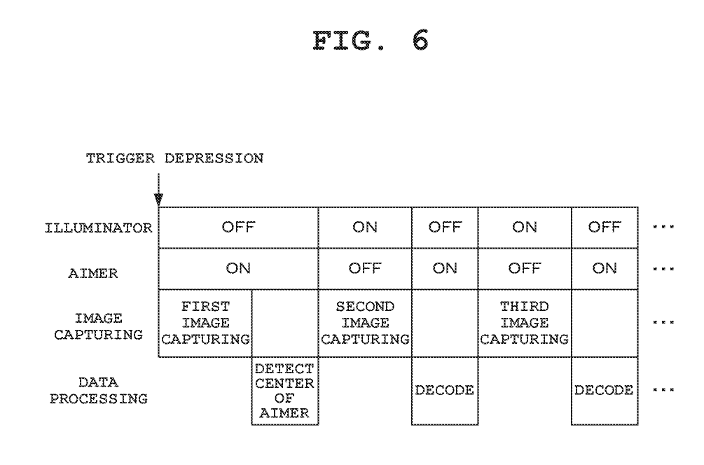

Next, the operation of the above-described scanner 1 according to the present invention is described with reference to FIG. 5 to FIG. 7C. FIG. 5 is a flowchart showing barcode reading processing which is performed by the CPU 11 in accordance with the control program in the ROM 12 when a worker who performs a task of reading a barcode presses the center trigger key 5b or the side trigger keys 10. Also, FIG. 6 is a timing chart showing a series of operations of the scanner 1 that is performed along with barcode reading processing and is a timing chart showing switch-on and switch-off timings of the illuminator 9 and the aimer 100, imaging timings of the camera 7 and the later-described processing timings of the CPU 11.

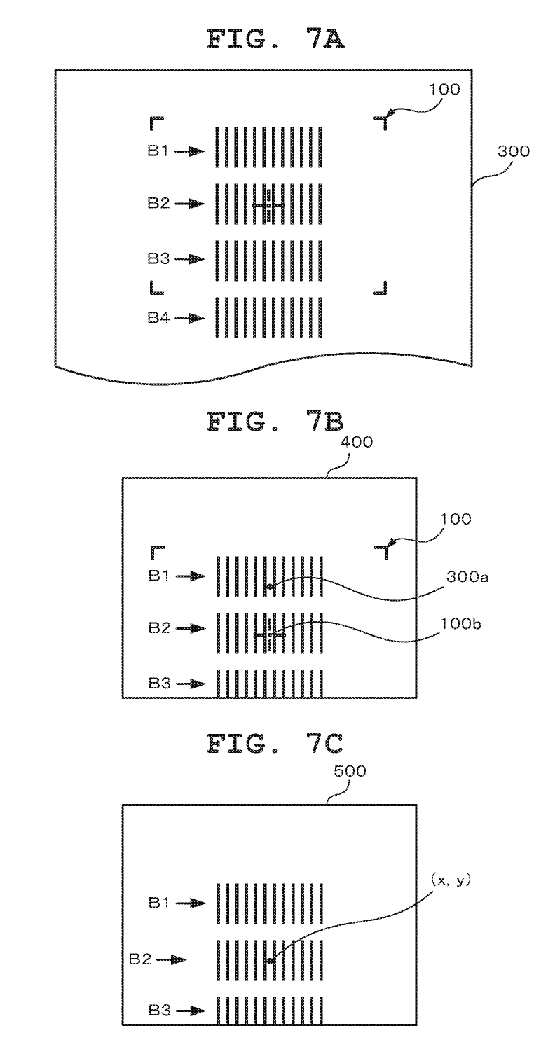

When barcode reading processing is started, the CPU 11 first turns on the aimer 100, as shown in FIG. 5 (Step S1). At this point, the illuminator 9 is off. FIG. 7A is a diagram showing an example of a display state of the aimer 100. More specifically, FIG. 7A is a diagram showing a state where a barcode to be read is a second barcode B2 from the top of a plurality of barcodes B1, B2, B3, B4, . . . vertically arranged close to one another on an order sheet 300 and therefore the aimer 100 has been displayed on the second barcode B2.

After turning on the aimer 100 in the processing of Step S1, the CPU 11 immediately controls the camera section 18 to perform image capturing, acquires a first captured image 400 such as that shown in FIG. 7B and temporarily stores the image data thereof in a predetermined area of the RAM 13 (Step S2). This image capturing based on the above-described processing is “first image capturing” according to the present invention. Note that FIG. 7B is a diagram showing an example of the first captured image 400 when the aimer 100 is displayed (projected) on the second barcode B2 as shown in FIG. 7A.

Next, the CPU 11 detects the center coordinates of the aimer 100 (i.e. the coordinates of the center point 100b) on the acquired first captured image 400 and temporarily stores the coordinate data thereof in a predetermined area of the RAM 13 (Step S3).

Next, the CPU 11 increments a count value n (whose initial value is “0”) that indicates the number of times barcodes have been read (Step S4), turns off the aimer 100, and turns on the illuminator 9 (Step S5). Note that this number of times barcodes have been read, which is indicated by the count value n, denotes not the number of times barcodes have been successfully read but the number of times barcode reading operations have been performed.

Next, the CPU 11 controls the camera section 18 to perform image capturing in that state, acquires a second captured image 500 such as that shown in FIG. 7C, and temporarily stores the image data thereof in a predetermined area of the RAM 13 (Step S6). This image capturing based on the above-described processing is “second image capturing” according to the present invention.

Next, the CPU 11 turns off the illuminator 9 and turns on the aimer 100 again (Step S7). Then, the CPU 11 performs barcode decoding on the second captured image 500 with an area near the center coordinates (x, y) stored in the processing of Step S3 (Step S8) as a target. In this processing, a barcode portion is identified by the detection of black bar portions and white bar portions being performed toward one end and the other end on a horizontal line with the center coordinates (x, y) as a starting point and information thereof is read. If no bar portions are detected on the horizontal line passing through the center coordinates (x, y), the CPU 11 widens the detection range to a range defined by a plurality of predetermined lines above and below the horizontal line so as to identify a barcode portion and then reads information.

As a result of this configuration, no matter where in the second captured image 500 a barcode indicated by the aimer 100 is located, the barcode (in FIG. 7C, the barcode B2) can be unfailingly read regardless of the position of the barcode in the second captured image 500.

Then, when the barcode is successfully decoded (read) (YES at Step S9), the CPU 11 outputs a decoding result (code data) to the external device via the communication section 21 (Step S10). In addition, the CPU 11 controls the speaker 6 of the sound emitting section 20 to emit a reading completion sound (Step S11) so as to notify the worker that the reading of the barcode has been completed. Note that this emission of a reading completion sound may be replaced by or paralleled with the blinking of the first indicator 3 or the second indicator 4.

Then, the CPU 11 judges whether an instruction to end the reading operation has been given (the depression of the center trigger key 5b or the like has been released) and, when an end instruction has been given (YES at Step S12), ends the barcode reading processing at that point. Note that, if the barcode decoding (reading) fails (NO at Step S9), the CPU 11 immediately judges whether an instruction to end the reading operation has been given and, when an end instruction has been given (YES at Step S12), ends the barcode reading processing at that point.

Conversely, when no end instruction has been given (NO at Step S12), the CPU 11 waits for processing for a predetermined period of time (e.g. 1 second or shorter) (Step S13), and then judges whether the above-described count value n has reached a preset value N which is a predetermined number of times of consecutive barcode reading. When the count value n has not reached the preset value N (NO at Step S14), the CPU 11 returns to the processing of Step S4 and repeats the subsequent processing.

That is, the CPU 11 performs second, third and . . . image capturing operations (each of which is “second image capturing” according to the present invention), and performs barcode decoding every time it performs an image capturing operation, as shown in FIG. 6. That is, the CPU 11 continuously performs the decoding of a new barcode with reference to the center coordinates of the aimer 100 acquired in the most recent processing of Step S3 and stored in the RAM 13 and the outputting of a decoding result.

As a result of this configuration, for example, in a case where the plurality of barcodes arranged on the order sheet 300 are read in sequence, the reading of another barcode can be automatically performed simply by the worker moving the aimer 100 onto the barcode by moving the scanner 1 while maintaining the reading distance to the barcode.

On the other hand, when the count value n reaches the preset value N while the CPU 11 is repeating the processing of Step S4 and the subsequent steps (YES at Step S14), the CPU 11 initializes the count value n (i.e. resets it to “0”) at that point (Step S15), turns off the illuminator 9, returns to the processing of Step S2 with the aimer 100 being kept turned on and repeats the processing of Step S2 and the subsequent steps.

That is, the CPU 11 acquires the center coordinates of the aimer 100 that serve as a reference in new image capturing (“first image capturing” according to the present invention) and performs barcode reading operations several times based on the acquired center coordinates. As a result, in the scanner 1, the operation shown in FIG. 6 is repeated all over again. Then, if an instruction to end the reading operation is given in the meantime (YES at Step S12), the CPU 11 ends the barcode reading processing at that point.

As described above, the scanner 1 according to the present embodiment is configured to read a barcode from a second captured image 500 acquired for barcode reading, with reference to the center coordinates (x, y) of the aimer 100 in a first captured image 400 acquired prior to the barcode reading. As a result of this configuration, no matter where in a second captured image 500 a barcode indicated by the aimer 100 is located, the barcode can be unfailingly read.

That is, at the time of manufacture of scanners 1, even if there are variations in the mounting positions of the cameras 7 and the aimer emitting devices 8 and the inclination of their optical axes from product to product and therefore the positions of barcodes to be read within the viewing angles vary from scanner to scanner, barcodes indicated by the aimers 100 can be unfailingly read without being affected by individual differences among the apparatuses. This effect is remarkable especially under a condition where plural barcodes are located close to one another as in the case of the order sheet 300. Moreover, at the time of manufacture of scanners 1, the inclination of the optical axes of the cameras 7 and the aimer emitting devices 8 does not need to be managed with high precision, which makes it possible to reduce the cost of manufacturing scanners 1.

Also, since the illuminator 9 is turned off at the time of image capturing for acquiring a first captured image 400, favorable contrast between a portion in the first captured image 400 where the aimer 100 is displayed and the other general portions can be secured, so that the center coordinates (x, y) of the aimer 100 can be more unfailingly and accurately detected.

During the sequential reading of the plurality of barcodes B1, B2, B3, B4, . . . vertically arranged close to one another on the order sheet 300, there is concern that the distance between the scanner 1 and the order sheet 300 varies as the number of times of reading operations increases. That is, there is concern that the emission position of the aimer 100 in the imaging area 200 varies.

However, in the present embodiment, every time the number of times of barcode reading (count value n) reaches a predetermined number of times of consecutive reading (preset value N), image capturing which is performed with the aimer 100 being emitted is newly performed and a coordinate point that serves as a reference for barcode reading is updated based on a second captured image 500 acquired by subsequent image capturing. Therefore, even when the distance between the scanner 1 and the order sheet 300 varies during the sequential reading of the plurality of barcodes B1, B2, B3, B4, . . . , a barcode indicated by the aimer 100 can always be unfailingly read.

In the present embodiment, each wait time for third and subsequent image capturing for acquiring second captured images 500 is fixed at a predetermined period of time (e.g. 1 second or shorter). However, this wait time may be a time that can be adjusted by a user as needed. For example, the scanner 1 may be configured such that the wait time is set to be longer until when the user becomes used to the scanner 1 or for an inexperienced user and, on the other hand, the wait time is set to be shorter after the user becomes used to the scanner 1 or for an experienced user.

Also, in the present embodiment, image capturing is repeated at predetermined time intervals while the center trigger key 5b or a side trigger key 10 is being depressed, and a barcode is read from each second captured image 500. However, for implementation of the present invention, a configuration may be adopted in which a barcode reading operation is performed only once every time the center trigger key 5b or a side trigger key 10 is depressed.

In that configuration, unlike the present embodiment, image capturing for acquiring a first captured image 400 and image capturing for acquiring a second captured image 500 may be performed in reverse order. That is, a configuration may be adopted in which “first image capturing” according to the present invention is performed after “second image capturing” according to the present invention.

While the present invention has been described with reference to the preferred embodiments, it is intended that the invention be not limited by any of the details of the description therein but includes all the embodiments which fall within the scope of the appended claims.

What is claimed is:

1. A barcode reading device comprising:
a camera which is used to capture a barcode;
an optical aiming device which emits an aim in an imaging direction of the camera; and
a processor which executes processing including:
imaging control processing of controlling the camera to successively perform first image capturing that is performed with the aim being emitted by the optical aiming device and second image capturing that is performed without the aim being emitted; and
reading processing of reading the barcode from a second captured image acquired by the second image capturing with reference to positional information of the aim in a first captured image acquired by the first image capturing.

2. The barcode reading device according to claim 1, wherein the reading processing is processing of setting a reading area in the second captured image with reference to the positional information of the aim and reading the barcode with the set reading area as a target.

3. The barcode reading device according to claim 1, further comprising:
an illumination device which emits auxiliary light in the imaging direction of the camera,
wherein the processor performs auxiliary light control processing of stopping emission of the auxiliary light by the illumination device during the first image capturing by the camera.

4. The barcode reading device according to claim 1, wherein the imaging control processing is processing of controlling the camera to repeatedly perform the second image capturing at predetermined time intervals after performing the first image capturing, and
wherein the reading processing is processing of reading a barcode from each of second captured images sequentially acquired by the second image capturing repeatedly performed at the predetermined time intervals, with reference to the positional information of the aim in the first captured image acquired by the first image capturing.

5. The barcode reading device according to claim 4, wherein the processor performs count processing of counting number of times of consecutive barcode reading by the reading processing from the second captured images sequentially acquired at the predetermined time intervals, and
wherein the imaging control processing is processing of controlling the camera to newly perform the first image capturing and then repeatedly perform the second image capturing at the predetermined time intervals, every time the number of times of consecutive barcode reading counted by the count processing reaches a predetermined number of times.

6. A barcode reading method for a barcode reading device including a camera which is used to capture a barcode, an optical aiming device which emits an aim in an imaging direction of the camera, and a processor, comprising:
an imaging control step of controlling the camera to successively perform first image capturing that is performed with the aim being emitted by the optical aiming device and second image capturing that is performed without the aim being emitted; and
a reading step of reading the barcode from a second captured image acquired by the second image capturing with reference to positional information of the aim in a first captured image acquired by the first image capturing.

7. The barcode reading method according to claim 6, wherein the reading step sets a reading area in the second captured image with reference to the positional information of the aim and reads the barcode with the set reading area as a target.

8. The barcode reading method according to claim 6, further comprising:
an auxiliary light control step of stopping emission of auxiliary light performed in the imaging direction of the camera by an illumination device, during the first image capturing by the camera.

9. The barcode reading method according to claim 6, wherein the image capturing control step controls the camera to repeatedly perform the second image capturing at predetermined time intervals after performing the first image capturing, and
wherein the reading step reads a barcode from each of second captured images sequentially acquired by the second image capturing repeatedly performed at the predetermined time intervals, with reference to the positional information of the aim in the first captured image acquired by the first image capturing.

10. The barcode reading method according to claim 9, further comprising:
a counting step of counting number of times of consecutive barcode reading by the reading step from the second captured images sequentially acquired at the predetermined time intervals,
wherein the imaging control step controls the camera to newly perform the first image capturing and then repeatedly perform the second image capturing at the predetermined time intervals, every time the number of times of consecutive barcode reading counted in the counting step reaches a predetermined number of times.

11. A non-transitory computer-readable storage medium having stored thereon a program that is executable by a computer in a barcode reading device including a camera which is used to capture a barcode, an optical aiming device which emits an aim in an imaging direction of the camera, and a processor, the program being executable by the computer to actualize processing comprising:
imaging control processing of controlling the camera to successively perform first image capturing that is performed with the aim being emitted by the optical aiming device and second image capturing that is performed without the aim being emitted; and
reading processing of reading the barcode from a second captured image acquired by the second image capturing with reference to positional information of the aim in a first captured image acquired by the first image capturing.

12. The computer-readable storage medium according to claim 11, wherein the reading processing is processing of setting a reading area in the second captured image with reference to the positional information of the aim and reading the barcode with the set reading area as a target.

13. The computer-readable storage medium according to claim 11, wherein the processing to be actualized by the computer executing the program includes auxiliary light control processing of stopping emission of auxiliary light performed in the imaging direction of the camera by an illumination device, during the first image capturing by the camera.

14. The computer-readable storage medium according to claim 11, wherein the imaging control processing is processing of controlling the camera to repeatedly perform the second image capturing at predetermined time intervals after performing the first image capturing, and
wherein the reading processing is processing of reading a barcode from each of second captured images sequentially acquired by the second image capturing repeatedly performed at the predetermined time intervals, with reference to the positional information of the aim in the first captured image acquired by the first image capturing.

15. The computer-readable storage medium according to claim 14, wherein the processing to be actualized by the computer executing the program includes count processing of counting number of times of consecutive barcode reading by the reading processing from the second captured images sequentially acquired at the predetermined time intervals, and
wherein the imaging control processing is processing of controlling the camera to newly perform the first image capturing and then repeatedly perform the second image capturing at the predetermined time intervals, every time the number of times of consecutive barcode reading counted in the count processing reaches a predetermined number of times.
